(19) United States
(12) Patent Application Publication
(10) Pub. No.: US 2019/0014623 A1
(43) Pub. Date: Jan. 10, 2019

(54) INDUCTION HEATING COOKER

(71) Applicant: Panasonic Intellectual Property Management Co., Ltd., Osaka (JP)

(72) Inventors: TAIHEI OGURI, Shiga (JP); TAKAYUKI AKASHI, Nara (JP); ISAO MIZUTA, Shiga (JP)

(73) Assignee: Panasonic Intellectual Property Management Co., Ltd., Osaka (JP)

(21) Appl. No.: 16/068,398

(22) PCT Filed: Feb. 10, 2017
(86) PCT No.: PCT/JP2017/004854

§ 371 Date: Jul. 6, 2018

(30) Foreign Application Priority Data
Feb. 25, 2016 (JP) 2016-034624

(51) Int. Cl. H05B 6/12; A47J 37/06

(52) U.S. Cl. CPC H05B 6/1209; H05B 6/129; A47J 37/0629

(57) ABSTRACT

Provided is an induction heating cooker which can be carried to a desired position on a cooking table to conduct grill cooking using induction heating and radiation heating and is configured such that a cooling fan forms an airflow in a plurality of vent channels inside a main body. The plurality of vent channels include a first vent channel. The first vent channel is configured such that an airflow from the cooling fan is directly guided from the cooling fan to an air outlet. The first vent channel is configured such that the airflow from the cooling fan and an airflow from a heating chamber are mixed.

### TECHNICAL FIELD

The present disclosure relates to an induction heating cooker for grill cooking in which, for example, meat, fish, or vegetables are grilled, and particularly relates to an induction heating cooker which is portable and usable at different cooking locations.

### DESCRIPTION OF THE RELATED ART

In the case of grill cooking in which a food item is directly heated by heat from a heat source, for example, when grilling meat, fish, or vegetables, a heating source (for example, a gas cooking stove or an electric cooking stove) installed in a home or commercial kitchen usually heats a griddle, a wire mesh, a frying pan, or the like to conduct cooking. Other examples of a cooking device for grilling meat, fish, and the like include a roaster oven installed in a kitchen. In order to prevent generation of smoke due to oil from an item to be heated falling on the heat source, the roaster oven is configured to grill the item to be heated by radiation heat applied from above and the side.

As mentioned above, in general, a heat source such as a stove installed in a home or commercial kitchen is used for grill cooking and therefore, the cooking is conducted at a predetermined fixed location. In the grill cooking, a heating device such as a griddle, a wire mesh, a frying pan, or the like is used on the heat source; temperature management and heating time adjustment for the heating device to grill a food item to desired doneness are very difficult and rely on cook's experience and instinct.

However, in the case of using the roaster oven which is a cooking device installed in a kitchen, temperature management and heating time adjustment for a grill tray can be set in advance, and thus it is possible to achieve preferred doneness to some extent (refer to Patent Literatures (PTLs) 1 and 2).

However, a roaster oven such as those proposed in PTLs 1 and 2 is a cooking device incorporated in an induction heating cooker installed in a home or commercial kitchen and thus is not portable. Therefore, grill cooking needs to be conducted at the location where the induction heating cooker is installed; the cooking location for grill cooking is restricted. Furthermore, since the roaster oven is incorporated as a part of the induction heating cooker installed in a home or commercial kitchen, a limited occupancy space is available to provide the roaster oven, resulting in a small heating area. Thus, for example, it is difficult to grill a large food item such as a pizza.

Furthermore, in the case of conducting grill cooking, since a food item is cooked with heat at high temperature, the temperature of the cooking device becomes high. Thus, the problem to be solved for the induction heating cooker capable of grill cooking is to enhance safety and reliability for users.

### CITATION LIST

### Patent Literature

PTL 1: Unexamined Japanese Patent Publication No. 2010-267422

PTL 2: Unexamined Japanese Patent Publication No. 2014-203635

### SUMMARY

An object of the present disclosure is to provide an induction heating cooker which is a cooking device with high safety and reliability for users that is capable of easily conducting grill cooking in which a food item is grilled to desired doneness, can be carried by a user, and is capable of grill cooking at a desired location.

Specifically, the present disclosure provides an induction heating cooker which is configured to conduct grill cooking using induction heating and radiation heating and can, for example, be carried to a desired position on a cooking table to conduct the grill cooking.

An induction heating cooker according to an aspect of the present disclosure is an induction heating cooker which is placeable on a table and includes: a main body including a heating chamber having a front opening sealable by a door; and a grill tray which is placed inside the heating chamber and includes an engaging section that is used for removing the grill tray from the heating chamber and inserting the grill tray into the heating chamber. The main body includes: an upper heating unit which is provided above the heating chamber and heats an interior of the heating chamber by radiation heating; a lower heating unit which is provided below the heating chamber and heats, by induction heating, the grill tray placed inside the heating chamber; a cooling fan which forms an airflow in one or more vent channels inside the main body; a control unit which drives and controls the upper heating unit, the lower heating unit, and the cooling fan; and a setting unit which sets a heating operation of the induction heating cooker. The one or more vent channels include a first vent channel configured to cause the airflow from the cooling fan to be directly guided from the cooling fan to an air outlet, and the airflow from the cooling fan and an airflow from the heating chamber are mixed in the first vent channel.

### BRIEF DESCRIPTION OF THE DRAWINGS

FIG. 1 is a perspective view illustrating the external appearance of an induction heating cooker according to the present exemplary embodiment of the present disclosure.

FIG. 2 is a perspective view illustrating an induction heating cooker according to the present exemplary embodiment with a door open.

FIG. 3 is a perspective view illustrating an induction heating cooker according to the present exemplary embodiment with a half of a grill tray taken out of a heating chamber.

FIG. 4 is a perspective view illustrating an induction heating cooker according to the present exemplary embodiment with a grill tray taken out of a heating chamber and placed on a table.

FIG. 5 is an exploded perspective view of a main body of an induction heating cooker according to the present exemplary embodiment.

FIG. 6 is a perspective view of an induction heating cooker according to the present exemplary embodiment with a main body cover removed.

FIG. 7 is a cross-sectional view of an induction heating cooker according to the present exemplary embodiment when viewed from the side.

FIG. 8 is a perspective view illustrating a grill tray used in an induction heating cooker according to the present exemplary embodiment.

FIG. 9 is a plan view illustrating a grill tray used in an induction heating cooker according to the present exemplary embodiment.

FIG. 10 is a cross-sectional view of the grill tray in FIG. 9 taken along line 10-10.

FIG. 11 is a bottom view of a grill tray used in an induction heating cooker according to the present exemplary embodiment.

FIG. 12 is a cross-sectional view of the grill tray in FIG. 9 taken along line 12-12.

FIG. 13 is a side view illustrating a grill tray used in an induction heating cooker according to the present exemplary embodiment.

FIG. 14 is a cross-sectional view of an induction heating cooker according to the present exemplary embodiment when viewed from the side in the state where a grill tray is placed in a cooking position inside a heating chamber.

FIG. 15 is a cross-sectional view of an induction heating cooker according to the present exemplary embodiment when viewed from the side in the state where a grill tray is placed in an intermediate holding position as a result of being pulled out from a heating chamber.

FIG. 16 is a perspective view illustrating an inner configuration of a main body of an induction heating cooker according to the present exemplary embodiment in the state where a grill tray is placed in an intermediate holding position.

FIG. 17 is a side view of an induction heating cooker according to the present exemplary embodiment with a main body cover removed.

FIG. 18 is a perspective view illustrating a configuration of a cooling fan in an induction heating cooker according to the present exemplary embodiment.

FIG. 19 is a back view of a cooling fan in an induction heating cooker according to the present exemplary embodiment.

FIG. 20 is a left-hand side view of a cooling fan in an induction heating cooker according to the present exemplary embodiment.

FIG. 21 is a perspective view of an induction heating cooker according to the present exemplary embodiment when viewed from the top right of a rear area on the back side.

FIG. 22 is a perspective view of an induction heating cooker according to the present exemplary embodiment when viewed from the bottom left of a rear area on the back side.

FIG. 23 illustrates a back surface of an induction heating cooker according to the present exemplary embodiment.

### DETAILED DESCRIPTION

An induction heating cooker according to the first aspect of the present disclosure is an induction heating cooker which is placeable on a table and includes: a main body including a heating chamber having a front opening sealable by a door; and a grill tray which is placed inside the heating chamber and includes an engaging section that is used for removing the grill tray from the heating chamber and inserting the grill tray into the heating chamber. The main body includes: an upper heating unit which is provided above the heating chamber and heats an interior of the heating chamber by radiation heating; a lower heating unit which is provided below the heating chamber and heats, by induction heating, the grill tray placed inside the heating chamber; a cooling fan which forms an airflow in one or more vent channels inside the main body; a control unit which drives and controls the upper heating unit, the lower heating unit, and the cooling fan; and a setting unit which sets a heating operation of the induction heating cooker. The one or more vent channels include a first vent channel configured to cause the airflow from the cooling fan to be directly guided from the cooling fan to an air outlet. The airflow from the cooling fan is directly guided from the cooling fan to the air outlet, and the airflow from the cooling fan and an airflow from the heating chamber are mixed in the first vent channel.

The configuration of the induction heating cooker according to the first aspect of the present disclosure makes it possible to easily conduct grill cooking in which a food item is grilled to desired doneness, and results in a cooking device with high safety and reliability for users.

In the induction heating cooker according to the second aspect of the present disclosure, the first vent channel according to the first aspect is configured to cause the airflow from the cooling fan and the airflow from the heating chamber to be combined after flowing in parallel.

With such a configuration, the temperature of air discharged from the induction heating cooker can be reduced to a level significantly lower than the temperature of high-temperature air directly discharged from the heating chamber.

In the induction heating cooker according to the third aspect of the present disclosure, the one or more vent channels further include a second vent channel configured to cause the airflow from the cooling fan according to the first or second aspect to flow into the heating chamber from a front side of the heating chamber, flow along the door of the heating chamber, and circulate inside the heating chamber.

With such a configuration, it is possible to keep the back surface of the door from fogging due to steam generated inside the heating chamber during cooking, or remove the generated fog.

In the induction heating cooker according to the fourth aspect of the present disclosure, the one or more vent channels further include a third vent channel configured to cause the airflow from the cooling fan according to any one of the first to third aspects to cool the lower heating unit by a vent channel passing along a lower surface of the heating chamber and be discharged from a back side of the main body.

With such a configuration, the lower heating unit which is a heat generation unit can be cooled.

In the induction heating cooker according to the fifth aspect of the present disclosure, the one or more vent channels further include a fourth vent channel configured to cause the airflow from the cooling fan according to any one of the first to fourth aspects to cool a high-heat generation region in the control unit, and cause the airflow that has cooled the high-heat generation region to cool the lower heating unit and be discharged from a back side of the main body.

With such a configuration, a plurality of heat generation units are efficiently cooled, and thus it is possible to ensure the reliability of the induction heating cooker.

Hereinafter, as an exemplary embodiment of an induction heating cooker according to the present disclosure, an example of an induction heating cooker which conducts grill cooking using induction heating (IH) and radiation heating in combination will be described with reference to the attached drawings. Note that the configuration of the induction heating cooker according to the present disclosure is not limited to the configuration of the induction heating cooker stated in the following exemplary embodiment and includes the configuration of an equivalent induction heating cooker with the technical idea described in the following exemplary embodiment.

The exemplary embodiment described below illustrates one example of the present disclosure; the configurations, functions, operations, and the like described in the exemplary embodiment are mere examples, and therefore do not limit the present disclosure. Among the structural elements in the following exemplary embodiment, structural elements not recited in the independent claim indicating the broadest concept are described as arbitrary structural elements.

Note that the grill cooking in the present description refers to a cooking method in which an item to be heated is directly heated by the heat from a heat source, meaning cooking with heat using a gridiron, an iron grate or stick (iron skewer), a metal plate, or the like to grill the item to be heated.

In the description of the exemplary embodiment below, a horizontal direction indicates a direction viewed from a user using the induction heating cooker, and the user side of the induction heating cooker is referred to as the front/forward (the front side) while the side opposite the user side is referred to as the rear/rearward (the back side). The left and the right in the description of the exemplary embodiment indicate the left-hand side and the right-hand side, respectively, when viewed from the front side of the induction heating cooker.

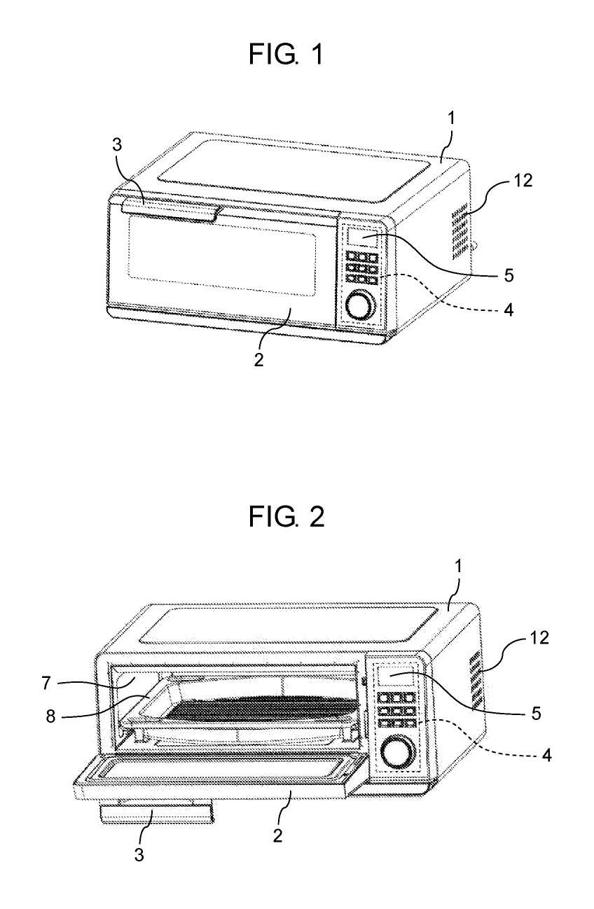

Hereinafter, the induction heating cooker according to the present exemplary embodiment of the present disclosure will be described with reference to the attached drawings. FIG. 1 is a perspective view illustrating the external appearance of an induction heating cooker according to the present exemplary embodiment of the present disclosure. FIG. 2 is a perspective view illustrating the induction heating cooker in FIG. 1 according to the present exemplary embodiment with a door open.

As illustrated in FIG. 1 and FIG. 2, the induction heating cooker is configured such that a front opening of heating chamber 7 provided inside main body 1 can be opened and closed by door 2. Door handle 3 is provided on an upper end section of door 2, and when a user grabs door handle 3 and opens door 2 from above by rotating door 2, the front opening of heating chamber 7 is opened upward. Closing door 2 practically seals the interior of heating chamber 7, and a food item which is an item to be heated placed inside heating chamber 7 is heated in the practically sealed state and thus placed in the state where grill cooking is conducted.

A food item that is placed inside heating chamber 7 is placed on grill tray 8 and cooked with heat (grilled). Positioning mechanisms to be described later are provided on grill tray 8 and an inner wall surface of heating chamber 7 so that grill tray 8 is reliably placed in a predetermined position on a flat bottom surface of heating chamber 7.

The front of the induction heating cooker includes, in addition to upwardly-opening door 2, setting unit 4 for a user to set various cooking conditions such as a cooking temperature and cooking time for cooking with heat. Setting unit 4 provided on the front of the induction heating cooker includes display unit 5 which displays the various cooking conditions, the heating state during cooking with heat, etc. In the configuration according to the present exemplary embodiment, setting unit 4 is placed to the right of door 2 from the users' viewpoint.

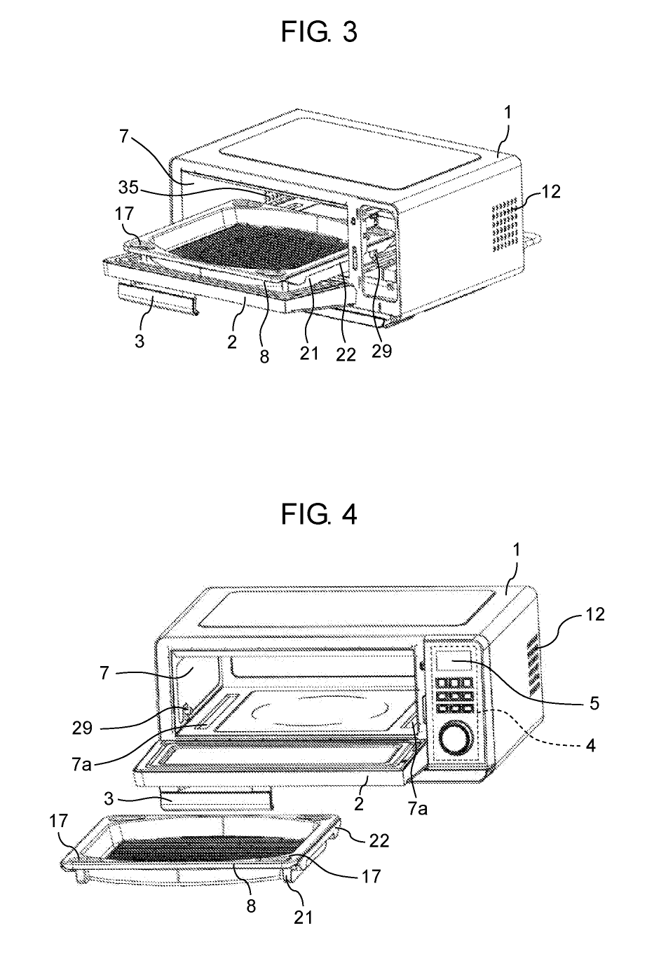

FIG. 3 is a perspective view illustrating the state in an intermediate holding position where a half of grill tray 8 is outside heating chamber 7. FIG. 3 illustrates the state where setting unit 4 is removed in order to illustrate the locking state of grill tray 8 to be described later. FIG. 4 illustrates the state where grill tray 8 is placed on a table, for example, on a cooking table, as a result of being taken out of heating chamber 7. In the configuration according to the present exemplary embodiment, the heating space of heating chamber 7 has the shape of a substantial cuboid greater in lateral length (which is the width of the front opening) than depth. One example of a specific shape of the heating space of heating chamber 7 is 350 mm (wide)×330 mm (deep)×110 mm (high). Grill tray 8 is in the shape of a rectangle corresponding to the shape of the bottom surface of the heating space of heating chamber 7 and is in the form of a tray with its entire peripheral edge raised.

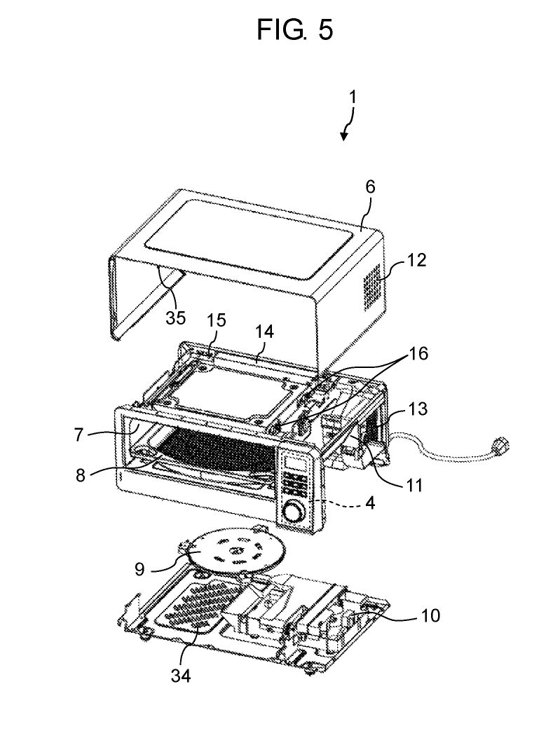

FIG. 5 is an exploded perspective view of main body 1 of the induction heating cooker according to the present exemplary embodiment, illustrating the state where door 2 is removed. As illustrated in FIG. 5, a heating coil which is lower heating unit 9 is provided below the bottom surface of heating chamber 7, and grill tray 8 placed inside heating chamber 7 is heated by induction of the heating coil. Control unit 10 which drives and controls lower heating unit 9 is provided at an elevation lower than lower heating unit 9, on the bottom side of main body 1, in a lower area on the back side of setting unit 4. Control unit 10 includes an inverter circuit board, a power supply circuit board, and the like which supply high-frequency current to the heating coil which is lower heating unit 9; thus, a plurality of heat generation components are arranged.

The induction heating cooker according to the present exemplary embodiment includes: an interior chamber temperature sensor which detects the temperature inside heating chamber 7; and a grill tray temperature sensor which detects the temperature of grill tray 8. The interior chamber temperature sensor is capable of using, for example, a temperature detecting means such as a thermistor and is used to control the interior chamber temperature such that the interior chamber temperature matches the cooking temperature set by setting unit 4. The grill tray temperature sensor is capable of using, for example, a temperature detecting means such as an infrared sensor or a thermistor and is used in the control for determining abnormality and stopping a heating operation, for example, when the temperature of grill tray 8 exceeds a preset temperature.

In the interior space of main body 1, sirocco-type cooling fan 11 is provided in a rear part of the area on the back side of setting unit 4. The axial direction of a rotary shaft of cooling fan 11 is parallel to the lateral direction (horizontal direction) of heating chamber 7; air is drawn through side air inlet 12 formed on a main body side surface (in the present exemplary embodiment, in a rear area of a right-hand side surface) and back air inlet 13 formed on a main body back surface (in the present exemplary embodiment, in a right-hand area of the back surface). Each of air inlets 12 and 13 is made up of a plurality of small openings. Note that guides for defining an intake direction may be provided on the openings.

As will be described later, an airflow formed by cooling fan 11 passes through a vent channel formed by a duct having a plurality of air intakes, efficiently cools a high-heat generation region in the induction heating cooker according to the present exemplary embodiment, and is discharged out of the device.

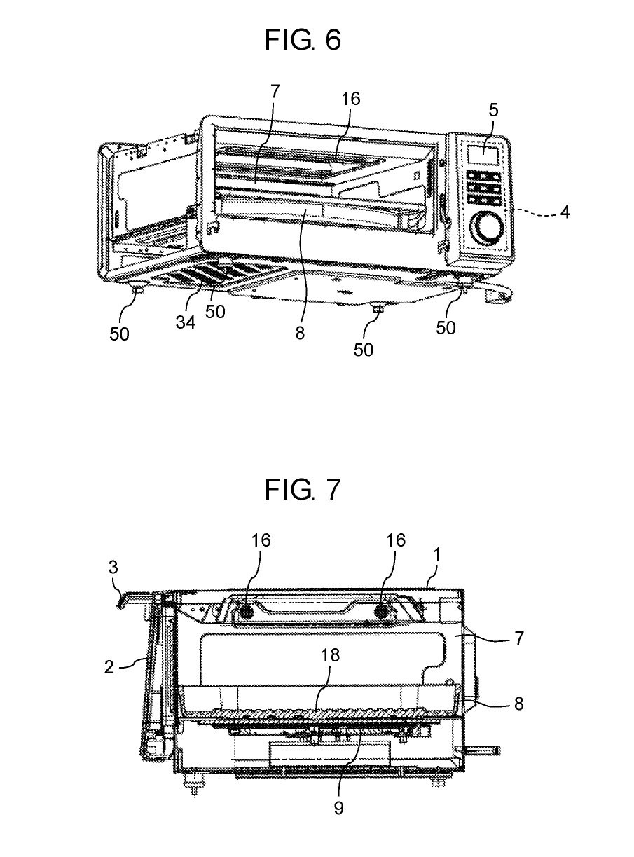

FIG. 6 illustrates main body 1 of the induction heating cooker with main body cover 6 removed when the front of main body 1 is viewed from below, illustrating the interior of heating chamber 7 in which grill tray 8 is housed. As illustrated in FIG. 6, upper heating unit 16, for example, a glass tube heater, is provided on the top of heating chamber 7. The interior of heating chamber 7 is heated with radiation heat from upper heating unit 16. In the present exemplary embodiment, two rod-like, horizontally-extending glass tube heaters are arranged in parallel as upper heating unit 16.

FIG. 7 is a cross-sectional view of the induction heating cooker according to the present exemplary embodiment when viewed from the side, illustrating the state where grill tray 8 is housed inside heating chamber 7 with door 2 closed. As illustrated in FIG. 7, the glass tube heaters serving as upper heating unit 16 are arranged in recesses formed on the ceiling of heating chamber 7. Recessed surfaces of the recesses in which upper heating unit 16 is provided function as a heat reflector for heating chamber 7 and are configured to be able to efficiently radiate heat to cooking surface 18 of grill tray 8 placed inside heating chamber 7. Note that upper heating unit 16 is not limited to the glass tube heater and can be configured using a heater such as a sheathed heater.

Furthermore, in the induction heating cooker according to the present exemplary embodiment, a sealing means, for example, a heat-resistant elastic body such as silicon rubber, is provided in a position corresponding to an outer peripheral portion of the front opening of heating chamber 7 so that when door 2 closes the front opening, the interior of heating chamber 7 is practically sealed. Note that the phrase “the interior of heating chamber 7 is practically sealed” means the state where water inside heating chamber 7 is inhibited from flowing out of the heating chamber. The sealing means may be provided on the main body side so as to surround the front opening of heating chamber 7 of main body 1 or may be provided on the door side, in a position that corresponds to the area surrounding the front opening of heating chamber 7. Note that the sealing means is preferably provided in a position that corresponds to the area surrounding the front opening of heating chamber 7 and is at least at an elevation higher than grill tray 8 housed in heating chamber 7.

As mentioned earlier, in the induction heating cooker according to the present exemplary embodiment, the heating space of heating chamber 7 is formed short in height compared to the width and depth (size) of the bottom surface thereof, for example, measuring 350 mm (wide)×330 mm (deep)×110 mm (high), and thus a food item placed on cooking surface 18 of grill tray 8 can be efficiently heated at high temperature with the radiation heat from upper heating unit 16. Furthermore, in the induction heating cooker according to the present exemplary embodiment, heating chamber 7 is formed short in height compared to the width and depth (size) of the bottom surface thereof, and the amount of air circulating between the heating space of heating chamber 7 and the outside of the cooker can be limited to a small amount. Therefore, in the induction heating cooker according to the present exemplary embodiment, heating chamber 7 is configured to be substantially sealed space, enabling, inside heating chamber 7, grill cooking in which a steaming operation using the water content of the food item is added to a grilling operation using radiation heating by upper heating unit 16 and induction heating by lower heating unit 9.

Furthermore, in the induction heating cooker according to Embodiment 1, leg portion 50 projecting downward is provided on the bottom surface of main body 1, as illustrated in FIG. 6. Leg portion 50 supports main body 1 when main body 1 is placed on a table. Furthermore, leg portion 50 provides a gap between main body 1 and the table and thus can suppress the effect heat has on the table.

### [Configuration of Grill Tray]

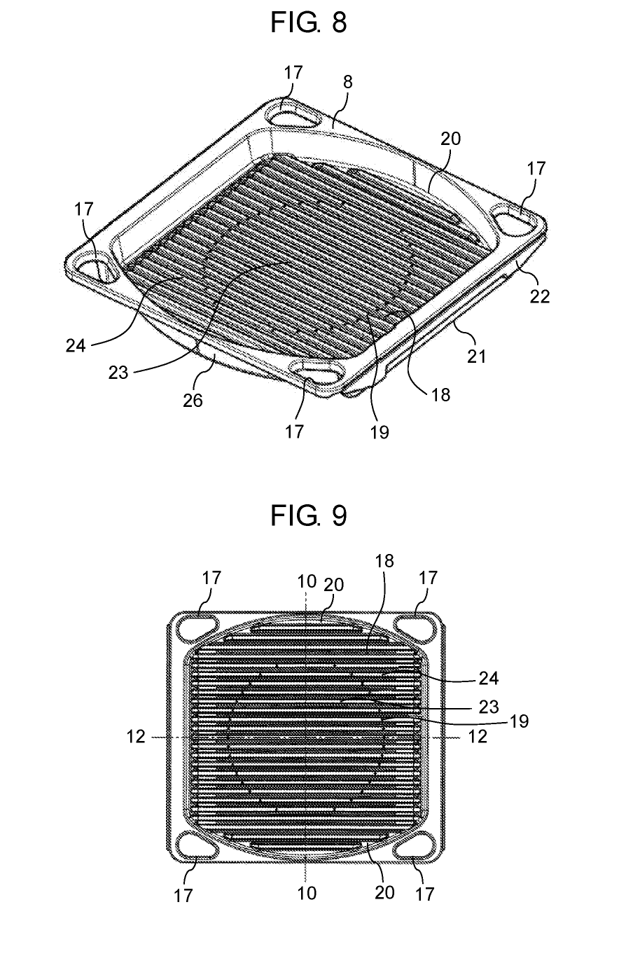

FIG. 8 and FIG. 9 each illustrate grill tray 8 used in the induction heating cooker according to the present exemplary embodiment; FIG. 8 is a perspective view thereof, and FIG. 9 is a plan view thereof. Grill tray 8 is in the shape of a substantial rectangle (including a substantial square) in a plan view and has a flanged edge section which has openings at four corners as grill tray hook portion 17. Grill tray hook portion 17 serves as a part (engaging section) on which a user hooks a kitchen mitten, a pan gripper, or the like when pulling out grill tray 8 after cooking from heating chamber 7. Grill tray hook portion 17, which is an engaging section, may be of any shape including not only the shape of an opening, but also the shape of a recess, a projection, or the like as long as the shape allows a user to pull out grill tray 8 with a finger, etc., hooked thereon.

The main part of grill tray 8 is thermal conductive portion 26 which is made of a high thermal conductive material, for example, a metal such as aluminum or copper. A central region of thermal conductive portion 26 that is surrounded by the edge section is cooking surface 18; cooking surface 18 is formed on an indented surface (bottom surface) of thermal conductive portion 26 that is dented relative to the edge section. Furthermore, a corrugated surface (wavy surface) made up of peaks and valleys extending in one direction is formed on cooking surface 18. In the present exemplary embodiment, the wavy form is defined by peaks and valleys extending in the horizontal direction of heating chamber 7.

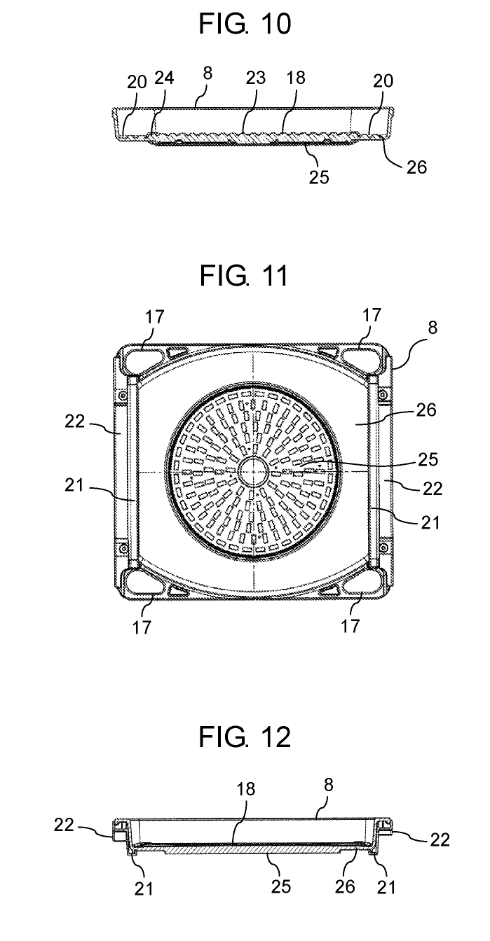

Water storage region 20 is formed on cooking surface 18 of grill tray 8. In grill tray 8 according to the present exemplary embodiment, water storage region 20 is provided in each of the positions forward and rearward of cooking surface 18. FIG. 10 is a cross-sectional view of grill tray 8 in FIG. 9 taken along line 10-10. As illustrated in FIG. 10, the lowest position of a valley section of water storage region 20 is formed lower in elevation than the lowest position of a valley section of cooking surface 18 other than water storage region 20. Furthermore, in cooking surface 18, water storage region 20 is separated from a region other than water storage region 20 by a peak section so that liquid stored in the valley section of water storage region 20 does not enter the valley section of cooking surface 18 other than water storage region 20.

Note that a peak section is formed also in water storage region 20 as is in cooking surface 18 other than water storage region 20. This is to prevent, when a food item is placed in water storage region 20, the food item from drooping down and touching water or the like in water storage region 20.

As mentioned above, in the present exemplary embodiment, since water storage region 20 is formed on cooking surface 18 of grill tray 8, the effect of steaming a food item can be produced using water coming from the food item and water stored in water storage region 20 during cooking with heat. Furthermore, as a result of configuring heating chamber 7 such that the interior thereof is practically sealed, the water is inhibited from flowing out of heating chamber 7, and thus the food item can be efficiently steamed. Thus, the induction heating cooker according to the present exemplary embodiment is capable of grill cooking while maintaining the water content of a food item itself.

FIG. 11 is a bottom view of grill tray 8. When grill tray 8 is disposed in a predetermined position (cooking position) inside heating chamber 7, the back surface of grill tray 8 is reliably and properly opposite the heating coil which is lower heating unit 9 disposed under the bottom surface of heating chamber 7 (refer to FIG. 7).

Induction heating body 25 is fixed or attached to thermal conductive portion 26 on the back surface of grill tray 8, in a region opposite lower heating unit 9 (heating coil) when grill tray 8 is in the cooking position. Note that induction heating body 25 is a disc-shaped magnetic body formed using a material having high magnetic permeability such as iron or stainless steel. With such a configuration, grill tray 8 is a small load for an inverter circuit and lower heating unit 9 and serves as a load that can be efficiently heated by induction. Induction heating body 25 is integrally fixed or attached to thermal conductive portion 26 formed of a high thermal conductive material, for example, aluminum or copper, by insert molding, riveting using rivets having recesses and projections, screw fastening, welding, or the like.

Grill tray 8 configured as described above includes, in a region opposite lower heating unit 9, induction heating body 25 which is efficiently heated by induction; this induction heating body 25 is fixed or attached to thermal conductive portion 26 formed of a high thermal conductive material. Therefore, grill tray 8 is efficiently heated by induction by lower heating unit 9 (heating coil) as an item to be heated and is placed in a high temperature state. Thus, a food item which is an item to be heated placed on grill tray 8 is cooked by induction heating via grill tray 8.

FIG. 12 is a cross-sectional view obtained by cutting off grill tray 8 in FIG. 9 along line 12-12 which corresponds to the position of the valley section of cooking surface 18. As illustrated in FIG. 12, induction heating body 25 provided on the back surface of grill tray 8 is formed having a flat back surface, and the back surface of grill tray 8 in the cooking position is in close contact with the bottom surface of heating chamber 7 in such a way that induction heating body 25 is opposite lower heating unit 9 (heating coil). In this cooking position, a projecting end of support portion 21 serving as a foot of grill tray 8, which will be described later, is disposed inside recess 7a (refer to FIG. 4) formed on the bottom surface of heating chamber 7.

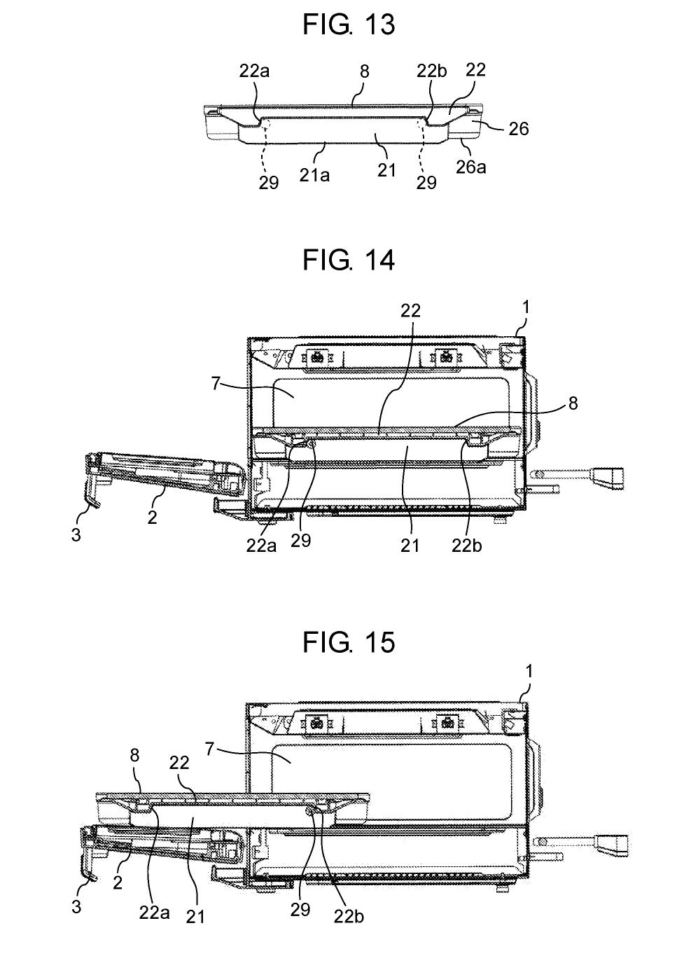

FIG. 13 is a side view illustrating a side surface of grill tray 8 that extends in the front-and-back direction, illustrating support portion 21 and abutment portion 22 which are provided on either side of grill tray 8 and each formed of a heat-resistant resin material. Support portions 21 and abutment portions 22 are fixed or attached to thermal conductive portion 26 which is the main body of grill tray 8 by a fixing or attaching means, for example, screw fastening, welding, or inserting. Support portions 21 and abutment portions 22 located on the both sides of grill tray 8 have substantially the same shapes.

As illustrated in FIG. 13, support portion 21 projects at an elevation lower than lower surface 26a which is in the lowest position in thermal conductive portion 26 serving as the main body of grill tray 8. Lower surface 21a of support portion 21 extends in the front-and-back direction of heating chamber 7 in which support portion 21 is housed and is configured into a flat surface. As mentioned above, support portions 21 are provided on the both sides of grill tray 8; thus, when grill tray 8 taken out of heating chamber 7 is placed on a table, for example, a cooking table, the projecting ends of support portions 21 serve as feet of grill tray 8. As a result, lower surface 26a of thermal conductive portion 26 of grill tray 8 is located a predetermined distance away from a placement surface of the table, and thus a predetermined space is formed between thermal conductive portion 26 of grill tray 8 and the placement surface of the table.

As illustrated in FIG. 4, the bottom surface of heating chamber 7 includes, on both sides, recesses 7a which are elongated in the front-and-back direction and in which the projecting ends of support portions 21 of grill tray 8 are housed. Furthermore, heating chamber projections 29 are provided on both side wall surfaces of heating chamber 7 (refer to FIG. 4) and are arranged so that abutment portions 22 of grill tray 8 engage heating chamber projections 29 when grill tray 8 is housed in heating chamber 7.

Abutment portion (engaging section) 22 provided on a side surface of grill tray 8 is a part of a positioning mechanism for defining a cooking position in which cooking with heat is conducted with grill tray 8 housed in heating chamber 7 and an intermediate holding position in which approximately a half of grill tray 8 is outside heating chamber 7 as a result of being taken out by a user. As illustrated in the side view of grill tray 8 in FIG. 13, abutment portion 22 has an indented shape such that the lower end of a central section thereof is dented upward. In indented abutment portion 22, a rising portion on the front side is first abutment section 22a and a rising portion on the back side is second abutment section 22b.

Heating chamber projections 29 (refer to FIG. 4) are formed on both side surface walls of heating chamber 7; heating chamber projections 29 are a part of a positioning mechanism which engages indented abutment portion 22 when grill tray 8 is in the process of being housed into heating chamber 7. When grill tray 8 is housed in heating chamber 7 and present in the cooking position, heating chamber projections 29 are in abutment with first abutment sections 22a, and thus grill tray 8 locks with heating chamber projections 29. At this time, the projecting end of support portion 21 serving as the foot of grill tray 8 is inserted into recess 7a (refer to FIG. 4) of the bottom surface of heating chamber 7.

FIG. 14 is a cross-sectional view illustrating, from the side, the state where grill tray 8 is placed in the cooking position inside heating chamber 7, as illustrated in FIG. 2 described earlier. FIG. 15 is a cross-sectional view illustrating, from the side, the state where grill tray 8 is placed in the intermediate holding position as a result of being pulled out from heating chamber 7, as illustrated in FIG. 3 described earlier.

When pulling out grill tray 8 in the cooking position illustrated in FIG. 14 from heating chamber 7, heating chamber projections 29 slide on the flat surfaces of indented abutment portions 22 and abut and lock with second abutment sections 22b. When grill tray 8 in the cooking position is pulled out from heating chamber 7 as just mentioned, the position in which heating chamber projections 29 abut second abutment sections 22b is referred to as the intermediate holding position (refer to FIG. 15). When grill tray 8 is in the intermediate holding position, support portions 21 of grill tray 8 are supported in contact with the inner wall of door 2 and the bottom surface of heating chamber 7.

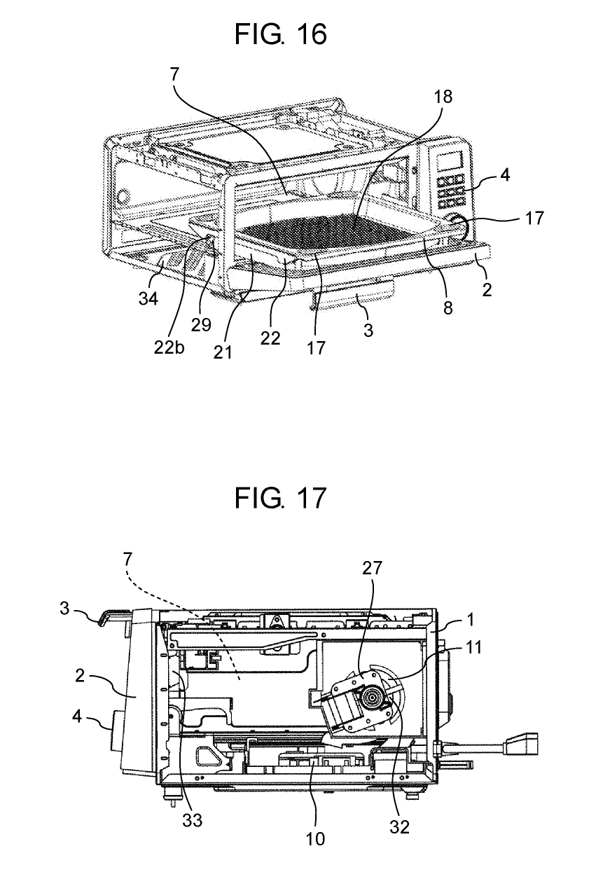

FIG. 16 illustrates the state where second abutment section 22b of abutment portion 22 provided on the left-hand side surface of grill tray 8 in the intermediate holding position locks with heating chamber projection 29 provided on the side wall surface of heating chamber 7. In FIG. 16, a front perspective view at an angle from the upper left corner is shown with main body cover 6, wall surfaces of heating chamber 7, etc., removed to illustrate second abutment section 22b and heating chamber projection 29 that are locking with each other. As mentioned above, abutment portions 22 provided on the both sides of grill tray 8 and heating chamber projections 29 provided on opposite wall surfaces of heating chamber 7 serve as the positioning mechanism according to the present exemplary embodiment.

As mentioned above, when grill tray 8 is in the intermediate holding position, at least a half of grill tray 8 is outside heating chamber 7, and grill tray 8 is supported by a back surface portion of door 2 and a bottom surface portion of heating chamber 7 (refer to FIG. 15). Therefore, a user can easily and safely take grill tray 8 out of heating chamber 7 by holding the indented sections of abutment portions 22 on the both sides of grill tray 8. Note that since grill tray 8 is horizontally symmetrical in shape, the front-and-back direction of grill tray 8 to be inserted into heating chamber 7 is not limited.

In grill tray 8 according to the present exemplary embodiment, since induction heating body 25 which is heated by induction is provided immediately below a central section of cooking surface 18 as mentioned above (refer to FIG. 11), a region of cooking surface 18 that corresponds to induction heating body 25 is heated to a high temperature (for example, 200° C. to 250° C.); then, this region serves as high-temperature cooking region 23 (refer to FIG. 8 and FIG. 9). A region of cooking surface 18 that is outside the region corresponding to induction heating body 25 is made of a high thermal conductive material, but is not a direct heat generation source, and thus serves as low-temperature cooking region 24 (refer to FIG. 8 and FIG. 9) which has a temperature (for example, 150° C. to 200° C.) lower than high-temperature cooking region 23.

Furthermore, as illustrated in FIG. 8 and FIG. 9, boundary mark 19 is displayed on cooking surface 18 so that a user can certainly recognize high-temperature cooking region 23 and low-temperature cooking region 24 of the cooking surface 18. Therefore, upon cooking with heat, a user can place a food item to be cooked at high temperature, for example, meat, fish, etc., in high-temperature cooking region 23 located inward of boundary mark 19, and place a food item to be cooked at low temperature, for example, vegetables, etc., in low-temperature cooking region 24 located outward of boundary mark 19. Thus, in the present exemplary embodiment, the use of grill tray 8 enables desired cooking with heat to be easily and reliably conducted in accordance with a food item and also in accordance with details of how the food item is to be cooked.

A non-sticky overcoat layer made of a fluorocarbon resin or a silicon resin, for example, may be formed on thermal conductive portion 26 which is the main body of grill tray 8 according to the present exemplary embodiment. When such an overcoat layer is formed, dirt such as oil and grease spattered during cooking and remaining debris after cooking can be prevented from sticking to grill tray 8, and even if such dirt sticks thereto, the dirt can be easily wiped out. Furthermore, thermal conductive portion 26 of grill tray 8 may be configured to have hydrophilic properties by blending a silane compound with a fluorine or silicon-based paint or varnish having high heat resistance or may be configured to have a function exhibiting superhydrophilic properties (the angle of contact with water is 10° or less) by blending, for example, a titanium dioxide which is a photocatalyst raw material with the fluorine or silicon-based paint or varnish.

Furthermore, grill tray 8 may include a coating layer which has a self-cleaning function of automatic cleaning by dissolving the oil and grease spattered during cooking through heating during cooking. Examples of a method for providing the coating layer with the self-cleaning function may include a method of blending the coating layer with a manganese-oxide-based catalyst species which promotes an oxidative degradation action, for example, and a method of adding, to the coating layer, platinum which exhibits a remarkable effect in the oxidative degradation action at low temperature or palladium which has high activity in a moderate to high temperature range. Furthermore, a method of adding, to the coating layer, cerium which exhibits adsorption, for example, may also be used.

As mentioned above, by using grill tray 8 in the induction heating cooker according to the present exemplary embodiment, it is possible to reliably conduct, in a short time, grill cooking such that a food item, i.e., meat, fish, vegetables, or the like, is grilled to desired doneness. Furthermore, this configuration allows grill tray 8 to be easily taken out of heating chamber 7 and also be easily washed after cooking.

### [Configuration of Vent Channel]

FIG. 17 is a side view of the induction heating cooker according to the present exemplary embodiment with main body cover 6 removed. As illustrated in FIG. 17, in the induction heating cooker according to the present exemplary embodiment, sirocco-type cooling fan 11 which forms an airflow is provided on the back side of setting unit 4, in a rear area of the side surface of heating chamber 7.

The axial direction of the rotary shaft of cooling fan 11 is parallel to the horizontal direction of heating chamber 7; air is drawn through side air inlet 12 formed on the main body side surface (in the rear area of the right-hand side surface) and back air inlet 13 formed on the main body back surface (in the right-hand area of the back surface) (refer to FIG. 5), and the air is suctioned into an intake of cooling fan 11. The airflow formed by cooling fan 11 passes through the vent channel formed downstream of cooling fan 11 by a duct having a plurality of air intakes, efficiently cools the high-heat generation region in the induction heating cooker according to the present exemplary embodiment, and is discharged.

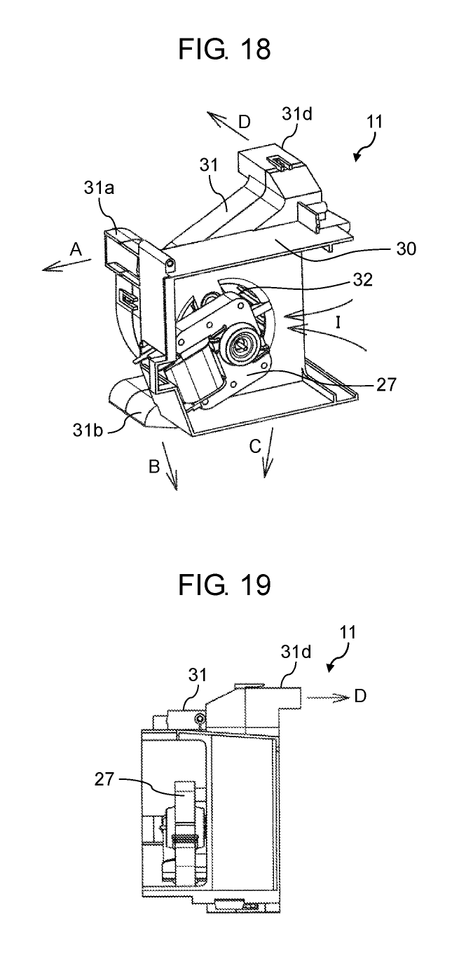

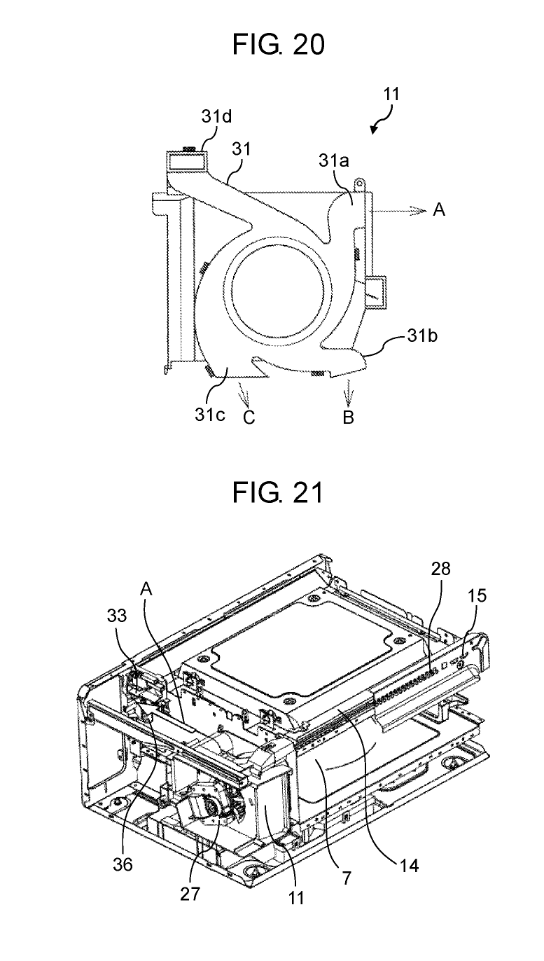

FIG. 18 is a perspective view illustrating a configuration of sirocco-type cooling fan 11. FIG. 18 is a front perspective view of cooling fan 11 viewed at an angle from the upper right corner, mainly illustrating the right-hand side surface thereof. FIG. 19 is a back view of cooling fan 11, and FIG. 20 is a left-hand side view of cooling fan 11. Cooling fan 11 is formed by attaching an impeller having a large number of cylindrically arranged blades to a rotary shaft of fan motor (for example, AC motor) 27, and is configured to draw air through inlet 32 located around the rotary shaft (refer to FIG. 18).

In cooling fan 11 in the induction heating cooker according to the present exemplary embodiment, as illustrated in FIG. 18, air (I) outside of the device is drawn into intake 32 located around the center of rotation of the rotary shaft through side air inlet 12 and back air inlet 13 of main body 1 (refer to FIG. 5). Air inlet duct 30 which substantially surrounds three sides (upper, lower, and front sides) is provided around intake 32 of cooling fan 11 (refer to FIG. 18) so that the air (I) outside of the device that has been drawn through side air inlet 12 and back air inlet 13 can reliably and smoothly flow into intake 32.

As illustrated in FIG. 18 to FIG. 20, cooling fan 11 according to the present exemplary embodiment includes air intake duct 31 (first to fourth vent channels) including four air intakes 31a, 31b, 31c, and 31d on outer peripheral portions. Air intake duct 31 forms, around cooling fan 11, a part of each of the practically four vent channels that are branched from cooling fan 11.

First airflow A supplied through first air intake 31a is delivered from cooling fan 11 toward the front, flowing in the vent channel (second vent channel) directed toward setting unit 4 illustrated in FIG. 17. First airflow A functions to cool, for example, an electric circuit board provided on the back side of setting unit 4, flow on a ceiling surface of heating chamber 7 from the front side to the back side, and discharge the heat of the ceiling surface of heating chamber 7 through back first air outlet 15 (refer to FIG. 5) formed at the top right on the back side of main body 1. Furthermore, first airflow A flows into heating chamber 7 from the front side of heating chamber 7 along the back surface of door 2 by heating chamber inflow guide 33 (refer to FIG. 17) provided on the back side of setting unit 4. Note that the air flowing in from heating chamber inflow guide 33 mainly has a function of removing fog on the back surface of door 2 formed by steam during cooking; the amount of such air as air flowing into heating chamber 7 is small. In the present exemplary embodiment, the airflow guided by heating chamber inflow guide 33 flows into heating chamber 7 through a plurality of small punch holes (inflow ports) 36 (refer to FIG. 21) formed on the side wall surface of heating chamber 7.

Thus, the second vent channel is configured such that part of first airflow A flows into heating chamber 7 from the front side of heating chamber 7, flows along door 2 of heating chamber 7, and circulates inside the heating chamber.

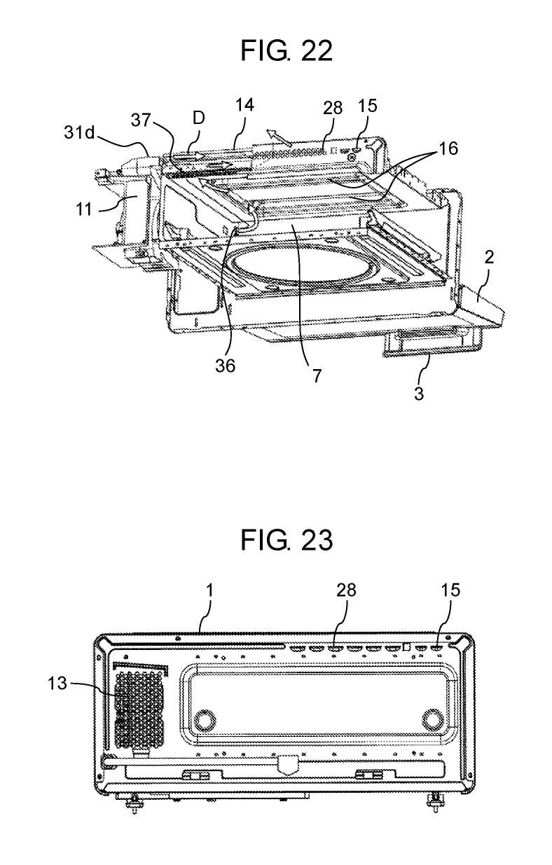

FIG. 21 and FIG. 22 illustrate the vent channel in which first airflow A from cooling fan 11 flows in the induction heating cooker according to the present exemplary embodiment; in each of the figures, parts not needed for description are removed. FIG. 21 is a perspective view of the induction heating cooker when viewed from the top right of a rear area on the back side, mainly illustrating cooling fan 11, heating chamber 7, and the like. FIG. 22 is a perspective view of the induction heating cooker when viewed from the bottom left of the rear area on the back side, illustrating the interior of heating chamber 7 from the back side. In FIG. 22, the bottom surface of heating chamber 7 is illustrated with lower heating unit 9, control unit 10, and the like removed.

As illustrated in FIG. 21, first airflow A from cooling fan 11 is guided by heating chamber inflow guide 33 provided on the back side of setting unit 4 and flows into heating chamber 7 through punch holes (inflow ports) 36 provided in an upper area on the front side of the right-hand side wall surface of heating chamber 7. The airflow that has flown into heating chamber 7 flows along the back surface of door 2 (not illustrated in the drawings) and circulates inside heating chamber 7.

As illustrated in FIG. 22, part of the airflow inside heating chamber 7 passes through opening 37 formed in the upper right area of a back wall of heating chamber 7 and flows into air discharge mixing pipe 14 provided in an upper area on the back side of heating chamber 7. This air discharge mixing pipe 14 is a vent channel (first vent channel) in which fourth airflow D to be described later which is directly delivered from cooling fan 11 to the upper area on the back side flows. Therefore, in air discharge mixing pipe 14, a high-temperature airflow from the interior of heating chamber 7 and a low-temperature airflow from cooling fan 11 flow a predetermined distance in parallel and are mixed before being discharged out of the device through back second air outlet 28 formed on the back side of main body 1. Note that a partition plate may be formed in a first half part of the interior of air discharge mixing pipe 14 so that the airflow from the interior of heating chamber 7 and the airflow from cooling fan 11 flow only the predetermined distance in parallel. As a result, the temperature of the air discharged through back second air outlet 28 is significantly lower than the temperature of the high-temperature air directly discharged from heating chamber 7.

FIG. 23 illustrates a back surface of the induction heating cooker according to the present exemplary embodiment. The back surface of main body 1 illustrated in FIG. 23 includes back air inlet 13 on the side of the right-hand side surface (on the left-hand side in FIG. 23) near cooling fan 11, which is illustrated in FIG. 22, and back first air outlet 15 on the side of the left-hand side surface (on the right-hand side in FIG. 23). Furthermore, back second air outlet 28 is formed in an upper right area on the back surface of main body 1, mixes fourth airflow D from cooling fan 11 and the airflow from heating chamber 7 illustrated in FIG. 22, and discharges the mixed airflows. In other words, fourth airflow D is directly led from cooling fan 11 to back second air outlet 28.

Note that in the present exemplary embodiment, a temperature detecting means, for example, a thermistor, detects the temperature of air that has been discharged from heating chamber 7 and just passed through opening 37. In other words, only the temperature of air that has been discharged from heating chamber 7 before being mixed with fourth airflow D is detected inside air discharge mixing pipe 14, and the grill cooking is controlled using the detected temperature as the interior chamber temperature.

As illustrated in the left-hand side view of cooling fan 11 in FIG. 20, in the four vent channels formed by air intake duct 31, second airflow B supplied through second air intake 31b is delivered downwardly forward (toward the lower front) from cooling fan 11. Second airflow B flows in the vent channel (fourth vent channel) for cooling, for example, control unit 10 including a heat generation component in the inverter circuit or the like provided in the lower area on the back side of setting unit 4. Furthermore, second airflow B that has cooled control unit 10, etc., is then guided to lower heating unit 9 (heating coil), cools lower heating unit 9, and is discharged, for example, through back surface air outlet 34 (refer to FIG. 5) formed on the back surface of main body 1 and side surface air outlet 35 (refer to FIG. 3) formed on the left-hand side surface of main body 1. Thus, the fourth vent channel is configured such that second airflow B cools the high-heat generation region in control unit 10, then cools lower heating unit 9, and is discharged from the back side of main body 1.

Third airflow C (refer to FIG. 20) supplied through third air intake 31c of air intake duct 31 is delivered downwardly backward (toward the back surface in a lower area) from cooling fan 11. Third airflow C flows in the vent channel (third vent channel) including a guide which directly guides the airflow to lower heating unit 9 (heating coil) and cools lower heating unit 9. Third airflow C that has cooled lower heating unit 9 is discharged, for example, through back surface air outlet 34 (refer to FIG. 5) formed on the back surface of main body 1, together with second airflow B. Thus, the third vent channel is configured such that third airflow C passes along the lower surface of heating chamber 7, cools lower heating unit 9, and is discharged from the back side of main body 1.

As illustrated in FIG. 18, fourth airflow D supplied through fourth air intake 31d of air intake duct 31 is delivered upward on the back side of cooling fan 11, flowing in air discharge mixing pipe 14 (first vent channel) (refer to FIG. 21 and FIG. 22) provided along an upper area on the back side of heating chamber 7. As mentioned earlier, air discharge mixing pipe 14 is configured such that part of first airflow A that has flowed through heating chamber 7 is delivered through opening 37 formed on the back-side wall surface of heating chamber 7.

As mentioned above, fourth airflow D from cooling fan 11 and the airflow from heating chamber 7 are mixed and discharged through back second air outlet 28 formed on the back surface of main body 1, and thus the air discharged on the back side of main body 1 has a low temperature. Therefore, in the case of the induction heating cooker according to the present exemplary embodiment, even when the induction heating cooker is placed on a cooking table and there are people around the induction heating cooker, for example, the induction heating cooker is a cooking device with high safety because the temperature of air discharged from the induction heating cooker is kept low.

It is sufficient that the first to fourth vent channels each have a function of passing the airflows, i.e., airflows A to D, and these vent channels may be configured to partially overlap one another.

As described above, the induction heating cooker according to the present exemplary embodiment is configured to be able to easily conduct cooking with heat in which a food item is grilled to desired doneness, and has a configuration such that, for example, the induction heating cooker can be placed in a desired position on a cooking table and conduct grill cooking; cooking with heat is possible at locations desired by users.

Furthermore, the induction heating cooker according to the present exemplary embodiment is configured such that the grill tray housed in the heating chamber is efficiently heated to a high temperature by induction heating, and in addition, is heated to a high temperature by radiation heating from above in the heating chamber, thus allowing a food item such as meat, fish, vegetables, or the like to be heated at a desired temperature, for example. Furthermore, in the induction heating cooker according to the present exemplary embodiment, since the induction heating is used, the rise to a preset temperature is quick, and thus cooking time can be reduced, allowing for efficient cooking with heat.

Furthermore, in the induction heating cooker according to the present exemplary embodiment, the heating chamber has sealing ability and is configured to cook a food item with heat in a reduced heating space, allowing for cooking with heat that is equivalent to cooking with steam while maintaining the water content of the food item itself. Furthermore, since the water storage region is formed on the cooking surface of the grill tray, water can be proactively supplied upon cooking with heat; a food item can be cooked with heat in a manner appropriate thereto.

The induction heating cooker according to the present exemplary embodiment performs the heating operation using the detected interior chamber temperature through the radiation heating from above and the induction heating from below in the heating chamber, and thus is configured such that the cooking temperature, the cooking time, and the like are easily and accurately controlled.

Furthermore, the heating space of the heating chamber in the induction heating cooker according to the present embodiment is in the shape of a substantial cuboid, and the bottom surface of the heating chamber has a substantially flat shape, allowing the interior of the heating chamber to be easily cleaned. In the grill cooking, a food item is cooked on the grill tray, and thus most of dirt is located on the grill tray. In the induction heating cooker according to the present exemplary embodiment, the grill tray can be easily taken out of the heating chamber, and since the shape of the grill tray is simple, it is easy to wash the grill tray, and moreover the grill tray according to the present exemplary embodiment is in the shape of an ordinary pan and thus can be washed in a dish washer.

### INDUSTRIAL APPLICABILITY

As described above, the induction heating cooker according to the present disclosure is configured to enable efficient cooking with heat using the induction heating and the radiation heating in combination and also be able to easily conduct grill cooking in which a food item is grilled to desired doneness, and moreover has a configuration such that a user can use the induction heating cooker at a desired location. Furthermore, the induction heating cooker is a cooking device with high safety and reliability for users. Thus, this cooking device is useful.

### REFERENCE MARKS IN THE DRAWINGS

1 main body

2 door

3 door handle

4 setting unit

5 display unit

6 main body cover

7 heating chamber

8 grill tray

9 lower heating unit (heating coil)

10 control unit

11 cooling fan

14 air discharge mixing pipe

15 back first air outlet

16 upper heating unit (sheathed heater)

17 grill tray hook portion

18 cooking surface

19 boundary mark

20 water storage region

21 support portion

22 abutment portion (engaging section)

23 high-temperature cooking region

24 low-temperature cooking region

25 induction heating body

26 thermal conductive portion

28 back second air outlet

29 heating chamber projection

30 air inlet duct

31 air intake duct (first to fourth vent channels)

31a first air intake

31b second air intake

31c third air intake

31d fourth air intake

32 inlet

1. An induction heating cooker placeable on a table, the induction heating cooker comprising:
a main body including a heating chamber having a front opening sealable by a door; and
a grill tray which is placed inside the heating chamber and includes an engaging section that is used for removing the grill tray from the heating chamber and inserting the grill tray into the heating chamber, wherein
the main body includes:
an upper heating unit which is provided above the heating chamber and heats the heating chamber by radiation heating;
a lower heating unit which is provided below the heating chamber and heats, by induction heating, the grill tray placed inside the heating chamber;
a cooling fan which forms an airflow in one or more vent channels inside the main body;
a control unit which drives and controls the upper heating unit, the lower heating unit, and the cooling fan; and
a setting unit which sets a heating operation of the induction heating cooker, and
the one or more vent channels include a first vent channel configured to cause the airflow from the cooling fan to be directly guided from the cooling fan to an air outlet, and the airflow from the cooling fan and an airflow from the heating chamber are mixed in the first vent channel.

2. The induction heating cooker according to claim 1, wherein
the first vent channel is configured to cause the airflow from the cooling fan and the airflow from the heating chamber to be combined after flowing in parallel.

3. The induction heating cooker according to claim 1, wherein
the one or more vent channels further include a second vent channel configured to cause the airflow from the cooling fan to flow into the heating chamber from a front side of the heating chamber, flow along the door of the heating chamber, and circulate inside the heating chamber.

4. The induction heating cooker according to claim 1, wherein
the one or more vent channels further include a third vent channel configured to cause the airflow from the cooling fan to pass along a lower surface of the heating chamber, cool the lower heating unit, and be discharged from a back side of the main body.

5. The induction heating cooker according to claim 1, wherein
the one or more vent channels further include a fourth vent channel configured to cause the airflow from the cooling fan to cool a high-heat generation region in the control unit, and cause the airflow that has cooled the high-heat generation region to cool the lower heating unit and be discharged from a back side of the main body.
